(19) United States
(12) Patent Application Publication
(10) Pub. No.: US 2004/0041020 A1
(43) Pub. Date: Mar. 4, 2004

(54) Data storage system and method with fingerprint identification for access authorization

(76) Inventors: Chun-Yu Chen, Taipei (TW); Nien-Tsu Chen, Taipei (TW)

Correspondence Address: BIRCH STEWART KOLASCH & BIRCH, PO BOX 747, FALLS CHURCH, VA, 22040-0747, US

(21) Appl. No.: 10/232,708

(22) Filed: Sep. 3, 2002

(51) Int. Cl. G06K 5/00

(52) U.S. Cl. 235/382

(57) ABSTRACT

A kind of data storage system and method with fingerprint identification applied for different access authorization is disclosed herein. A user is able to utilize an executable computer program 1 and a built-in fingerprint identification module of the data storage device for processing the operations of user identity recognition and data access. Moreover, different users are able to process the operations of data access and access administration with different access authorization utilizing the same user operation interface.

### BACKGROUND OF THE INVENTION

1. Field of Invention

The invention relates to a data access system and method. More particularly, it is a kind of system and method applied to a plug and play (PnP) portable data storage device, which connects to a PC terminal, utilizing an executable computer program for executing user authorization of data access and access administration.

2. Related Art

With the coming of the age of mobile commerce, mobile commodities such as mobile phones, hand-hold personal digital assistance (PDA) and portable laptops emphasize the need for small and lightweight size, full-functions and portability. The development of personal mobile commodities does not remain stagnant but makes great progress toward pluralistic applications. One of the hottest topics among currently developed mobile commodities is the portable data storage device, which, relying on its convenience of usage, plays an indispensable role in today's mobile commerce and further creates another new trend in the m-commerce world.

For providing complete convenience of usage, currently used portable data storage devices usually employ their PnP characteristics to enable users to easily connect with another PC terminal for further data access. Therefore, there is no particular prevention mechanism for controlling data security. Some portable data storage devices apply data methods such as encrypting, encoding and compressing during data storage to prevent data from being obtained from others while the device is lost. Although these methods maintain some security, they still cause considerable inconvenience to users accessing data. For instance, it is inefficient for a user to have to pass through complicated data procedures like decrypting, decoding, decompressing, and strict mechanisms of declassifying passwords before s/he retrieves required data. There have been some troublesome problems of conventional password mechanisms that hinder data access, including overlapping password with others, passwords being forgotten and stolen, etc. This causes inconvenience to users, as they need to memorize groups of passwords that correspond to various password mechanisms. It also causes a user to be unwilling to use portable data storage devices, and makes them less popular.

Therefore, combining developed computer software/hardware technology with current portable data storage devices with matured and simplified identity recognition technology in order to establish a complete and secure data access control mechanism for the portable data storage devices will heighten usage willingness and popularization of portable data storage devices.

### SUMMARY OF THE INVENTION

In view of the aforementioned problems, the object of the invention is to provide a data storage system and method with fingerprint identification applied for different access authorization. The invention aims at achieving user authorization for data access and access administration through authorization-setting by processing an executable computer program on a PC terminal, which is connected to a data storage device. To achieve the aforementioned objects, the disclosed data storage system and method with fingerprint identification applied for different access authorization consists of : a data storage module, a transmission interface module, a fingerprint identification module, and a control module.

Furthermore, the data storage system and method with fingerprint identification applied for different access authorization consists of the following steps: firstly, connecting the data storage device with the said terminal, receiving a fingerprint image for executing the identification operation, automatically programming access administration and generating a user operation interface, retrieving content from a corresponding data list to start up and display a corresponding access item for an authorized user, and finally , executing data storage/retrieval of a corresponding item selected by the user.

The detailed content and technology of the invention is depicted by the following figures and descriptions.

### BRIEF DESCRIPTION OF THE DRAWINGS

FIG. 1 is the systematic structure of the disclosed data storage system and method with fingerprint identification applied for different access authorization according to the invention;

FIG. 2-a is a flowchart of data access and administration of the disclosed system and method; and

FIG. 2-b is a flowchart of data access and administration of the disclosed system and method.

### DETAILED DESCRIPTION OF THE INVENTION

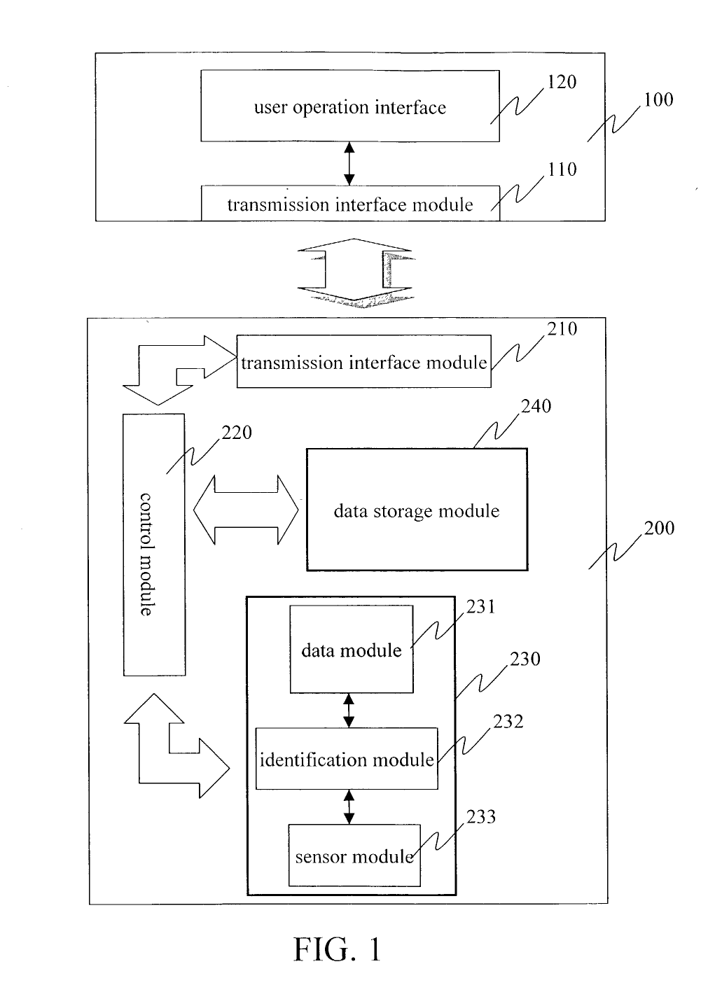

The invention is a kind of data storage system and method with fingerprint identification applied for different access authorization. It applies fingerprint identification to the data storage device 200 to establish different authorization mechanisms of data access and access administration among different users through the assistance of an executable computer program on a connected terminal 100, which connects to the said data storage device. It enables personal data to be maintained at higher levels of security and confidentiality. All communication messages and data transfer operations between the data storage device 200 and the connected PC terminal 100 are carried out through their transmission interface modules 110 and 210, respectively. FIG. 1 illustrates the systematic structure of the disclosed system and method. Details are provided as follows:

(1) The transmission interface module 210 processes data transfer from a data storage module 240 and delivers messages of user access administration from the PC terminal 100.

(2) A control module 220 enables the control of access functions for data transfer according to an access control command generated by a fingerprint identification module 230. It further transfers an access administration program to the connected PC terminal 100 for execution and controls message delivery of data access administration from the connected terminal 100 by a user's operation.

(3) The fingerprint identification module 230 receives a fingerprint image from the user to process the identification operation. It further generates an access control command to the control module 220 and allows the user to access data after the user is identified through the identification operation. The fingerprint identification module 230 further consists of the following modules:

(a) A data module 231 stores all legally identified user data (i.e. recognized fingerprint data) in the data storage device 200.

(b) An identification module 232 retrieves fingerprint characteristics inputted by a user to be contrasted, one by one, with all recognized data stored in the data module 231.

(c) A sensor module 233 receives a fingerprint image from a user and transfers the image to the identification module 232 for subsequent processing.

(4) The data storage module 240 stores all data content of authorized users and further stores an executable computer program, which is provided for users to process data access administration by the disclosed invention, and a corresponding data list. The said executable access administration program is transferred from the control module 220 to be executed by the connected terminal 100 after a user passes through the identification process. After the program execution a user operation interface 120 is generated for displaying all corresponding access items related to the user for him/her to process the operation of selection (including adding a corresponding access item, modifying a corresponding access item and deleting a corresponding access item).

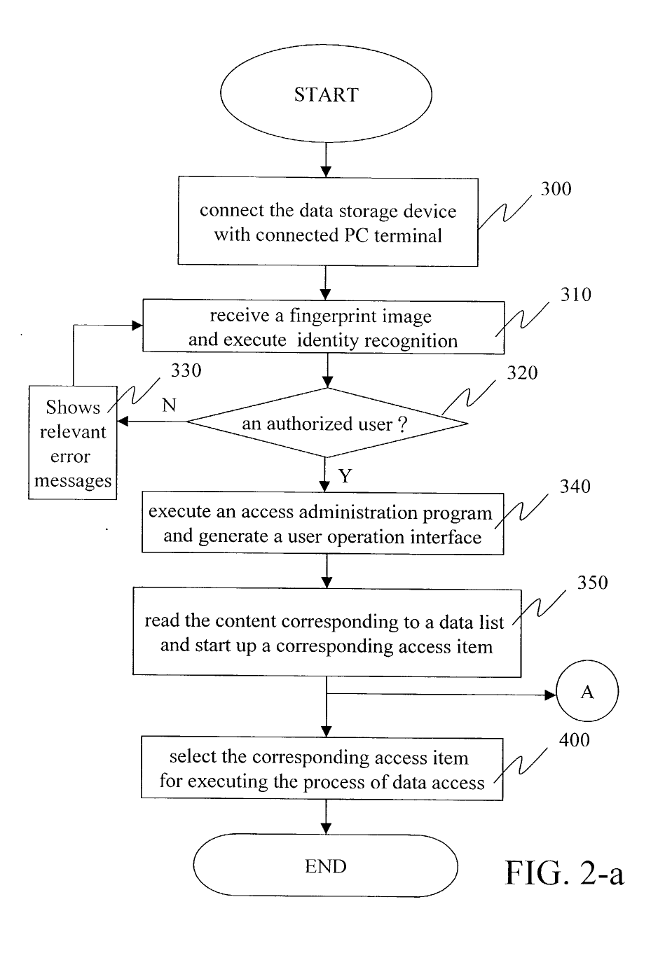

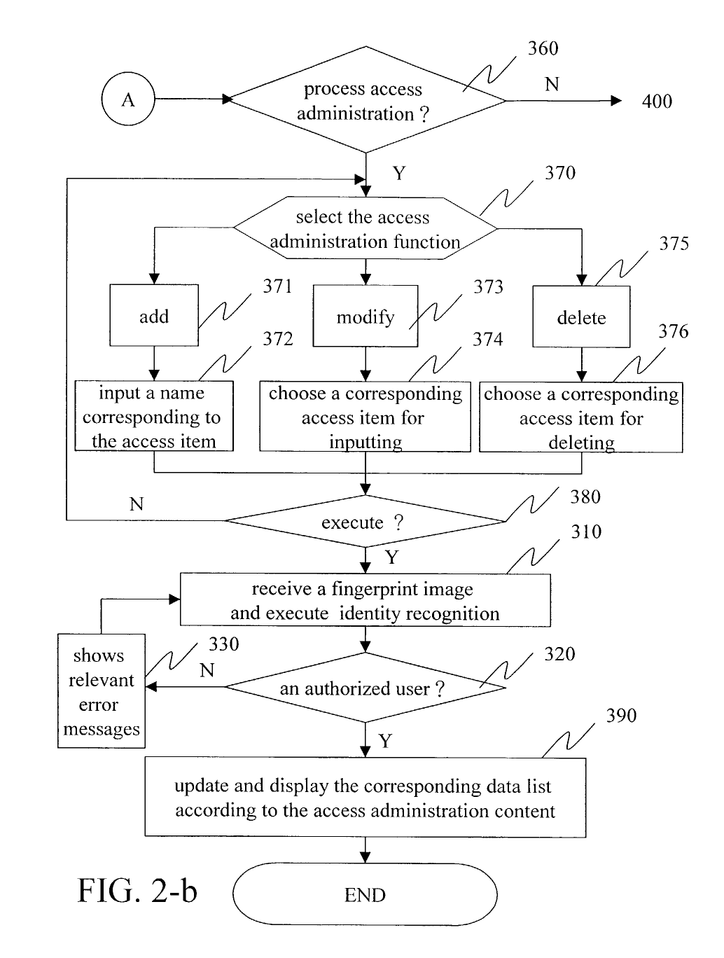

Subsequently, the data access and administration flow are shown in FIGS. 2-a and 2-b. Details are described as follows.

First, the data storage device 200 must connect with another connected PC terminal 100 (step 300) before a user can process data access from the data storage device 200. After connection, the data storage device 200 automatically enters into an input/retrieval mode and starts receiving an inputted fingerprint before executing identity recognition (step 310). Following the identity recognition process, the system further verifies whether the user is an authorized user (step 320). If NO, the system shows relevant error messages (step 330); otherwise, it shows that the user is an authorized user. The flow then goes into step 340. The control module retrieves the access administration program from the data storage module 240 and transfers it to the connected PC terminal 100 for program execution. The user operation interface 120 is then generated from the connected terminal 100. The system then reads recorded content on the corresponding data list and starts up, one by one, all corresponding access items that belong to the user, i.e., access authorization of corresponding access items, to be shown to the user through the user operation interface 120 (step 350). If the user wants to process any access administration, the flow goes into process A, which will be further described below. Otherwise, if the user simply wants to process access to his/her previous stored data, s/he can directly select corresponding access items shown on the user operation interface 120 for executing the respective processes of data access (e.g. adding, modifying, deleting, moving, copying, etc.) (step 400). Herein, the main flow of whole data access process is completed.

Process A mainly describes the steps while a user is processing access administration. First, the system verifies whether the user wants to process access administration operations (step 360). If NO, it goes back to step 400, and the user can directly select corresponding access items shown on the user operation interface 120 for executing the respective processes of data access. If YES, the system provides the functions of access administration (including adding a corresponding access item, modifying a corresponding access item and deleting a corresponding access item) for the user's selection (step 370). If the user chooses the adding function (step 371), s/he must input a corresponding access item name that s/he wants to add (step 372). If the user chooses the modifying function (step 373), s/he must choose a corresponding access item that s/he wants to modify before inputting its content name (step 374). If the user chooses the deleting function (step 375), s/he can simply choose a corresponding access item (step 376). After input or selection is done, the system further confirms whether the user wants to execute that function (step 380). If the user does not reply for confirmation, the flow goes back to step 370 to re-start access administration for selection; or, the system carries out another user identification operation, that is, retrieving inputted fingerprint data of the user and executing identity recognition (step 310). The system, through the identification operation, verifies whether the user is an authorized user (step 320). If NO, the system shows the relevant error message (step 330); otherwise, it executes the update of recorded content corresponding to the data list according to access administration content processed by the user. The updated columns include a corresponding item name, pointer of the corresponding item name, an authorized user name and identification data pointer of the authorized user. In the meantime, the system instantly displays the updated result on the user operation interface (step 390).

### ACHIEVEMENTS OF THE INVENTION

The invention is a kind of a data storage system and method with fingerprint identification technology for different access authorization. It not only applies to plug and play (PnP) portable data storage devices utilizing fingerprint identification technology for processing user identity recognition, but also establishes mechanisms of data access and access administration to enable different users of the same device to maintain data confidentiality among them, so as to achieve higher data security and confidentiality.

Moreover, the executable program on the connected PC terminal to the data storage device enables different users to process personalized and simplified data access and access administration under the same user operation interface. It further increases the convenience of using portable data storage devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A kind of data storage system and method with fingerprint identification applied for different access authorization utilizes fingerprint identification technology for user identity recognition and executes an executable computer program on a PC terminal, which connects to a data storage device for data access and administration among users. The said system comprises:
a data storage module, which stores a user's data content, an executable computer program for access administration and a corresponding data list;
a transmission interface module, which carries out data transfer of the data storage module and deliver access administration messages;
a fingerprint identification module, which receives a fingerprint image for carrying out the identification operation, generates an access control command to proceed access to stored data, further comprising:
a sensor module, which receives a fingerprint image and transfers it for identification;
a data module, which stores all recognized data for all authorized users; and
an identification module, which retrieves the characteristic features of the fingerprint image as contrasted with stored recognized data for proceeding the identification operation; and
a control module, which enables the control of access function for data transfer, according to a generated access control command, transfers and executes the access administration program and controls message delivery of data access and the administration operation.

2. The invention as recited in claim 1, wherein the access administration program is executed on the PC terminal after the authorized user passes through the identification operation.

3. The invention as recited in claim 1, wherein the access administration program is being executed thereafter, a user operation interface is generated for displaying a corresponding access item, which enables a user to proceed data access and an access administration.

4. The invention as recited in claim 1, wherein the said access administration consists of adding, modifying and deleting the corresponding access item.

5. The invention as recited in claim 3, wherein the said corresponding access item is accessible data item in the corresponding data list of the authorized user.

6. The invention as recited in claim 1, wherein the said corresponding data list includes the corresponding access item name, the corresponding access item pointer, the authorized user name and data pointer of the authorized user.

7. The invention as recited in claim 1, wherein the system further instantly executes the update of the corresponding data list and re-displays the result, according the access administration content.

8. A kind of data storage system and method with fingerprint identification applied for different access authorization utilizes fingerprint identification technology for user identity recognition and executes an executable computer program on the PC terminal, which connects to a data storage device for data access and administration among users. The said method comprises the following steps:
connecting the data storage device with the PC terminal;
receiving a fingerprint image for executing an identification operation;
executing an access administration program and generating a user operation interface;
reading a content of a corresponding data list and starting up a corresponding access item of an authorized user and displaying the result; and
selecting the corresponding access item and executing data access.

9. The invention as recited in claim 8, wherein the access administration program is executed on the connected PC terminal after the authorized user passes through the identification operation.

10. The invention as recited in claim 8, wherein said access administration program is responsible for carrying out data access and an access administration for the authorized user.

11. The invention as recited in claim 8, wherein said access administration consists of adding, modifying and deleting the corresponding access item.

12. The invention as recited in claim 8, wherein the said access administration further consists of the following steps:
selecting the access administration;
confirming execution;
receiving the fingerprint image and executing the identification operation; and
executing the update of the corresponding data list and re-displays the result, according to the access administration content.

13. The invention as recited in claim 8, wherein the said corresponding access item is recorded accessible data item of the authorized user.

14. The invention as recited in claim 8, wherein the said corresponding data list includes the corresponding access item name, the corresponding access item pointer, the authorized user name and data pointer of the authorized user.
